(19) United States
(12) Patent Application Publication
(10) Pub. No.: US 2026/0113249 A1
(43) Pub. Date: Apr. 23, 2026

(54) SYSTEMS AND METHODS FOR IOT DEVICE MODELING AND INTERFACING

(71) Applicant: State Farm Mutual Automobile Insurance Company, Bloomington, IL (US)

(72) Inventor: Arsh Singh, Frisco, TX (US)

(73) Assignee: State Farm Mutual Automobile Insurance Company, Bloomington, IL (US)

(21) Appl. No.: 19/017,201

(22) Filed: Jan. 10, 2025

Related U.S. Application Data
(60) Provisional application No. 63/708,407, filed on Oct. 17, 2024.

(51) Int. Cl. H04L 41/16; G06F 9/54; H04L 67/12

(52) U.S. Cl. CPC H04L 41/16; G06F 9/541; H04L 67/12

(57) ABSTRACT

In various examples, computer systems and computer-implemented methods interface with a plurality of Internet of Things (IoT) devices within a local network of a residential building using one or more artificial intelligence (AI) models. The system may (i) receive at least one transmission of an IoT device of a plurality of IoT devices connected within the local network; (ii) determine, using the at least one transmission, at least one of a protocol, a command, or a data format of the IoT device; (iii) generate and store a device dataset including at least one of the protocol, the command, or the data format of the IoT device; (iv) receive, via a user interface, a natural language input corresponding to the IoT device; and/or (v) generate a natural language response to the natural language input using retrieval-augmented generation.

### FIELD OF THE INVENTION

The present disclosure generally relates to Internet of Things (IoT) device management, artificial intelligence (AI), and natural language processing systems. More particularly, according to some implementations, the present systems and methods relate to using a centralized system to manage, control, and process transmissions from IoT devices, facilitating real-time monitoring, control, and natural language interactions with various IoT devices in networks.

### BACKGROUND

Individuals and organizations may use various systems to manage and control IoT devices in both residential and commercial settings. For instance, property managers may use connected systems to monitor devices such as security systems and industrial sensors, while businesses may use similar technologies to track operational systems and building equipment.

However, different types of IoT devices, with varying communication protocols, data formats, and control commands, may pose challenges for efficient interactions, management, and/or integration. Conventional techniques may also have certain inefficiencies, inconsistencies, and operational limitations, particularly in managing multiple devices and providing user interaction through natural language interfaces.

### BRIEF SUMMARY

A modeling system may be provided that, inter alia, interfaces with a plurality of Internet of Things (IoT) devices within a local network of a residential building (e.g., a domicile) using one or more artificial intelligence (AI) models. The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT bots, InstructGPT bots, Codex bots, Google Bard bots, and/or other electronic or electrical components, which may be in wired or wireless communication with one another and which may be implemented as data input devices, data or analysis output devices, and/or data generating, collecting, gathering, and/or presenting devices.

For example, in one instance, the computer system may include one or more local or remote memory devices having instructions stored thereon that, when executed by one or more local or remote processors, cause the one or more processors to perform operations including (1) receiving at least one transmission of an IoT device of a plurality of IoT devices connected within the local network; (2) determining, using the at least one transmission, at least one of a protocol, a command, or a data format of the IoT device; (3) generating and storing a device dataset including at least one of the protocol, the command, or the data format of the IoT device; (4) receiving, via a user interface, a natural language input corresponding to the IoT device; and/or (5) generating a natural language response to the natural language input using Retrieval-Augmented Generation (RAG) by: (5a) applying the device dataset and the natural language input as input to the one or more AI models to cause the one or more AI models to generate an output including one or more interfacing commands for initiating communications with the IoT device based upon at least one of the protocol, the command, or the data format of the IoT device; (5b) initiating a communication with the IoT device using the one or more interfacing commands to obtain a status or configuration of the IoT device; and/or (5c) providing or presenting, via the user interface, the natural language response including the status or configuration of the IoT device. The computer system may include additional, less, or alternate functionality and/or operations, including that discussed elsewhere herein.

In some implementations, the status or configuration of the IoT device may include sensor information corresponding to a sensor monitoring a subsystem of the residential building, and the natural language input may include a request to obtain the sensor information or control the sensor.

In various implementations, the sensor monitoring the subsystem may include at least one of a sump pump sensor, a water heater sensor, a HVAC sensor, a smoke detector, a carbon monoxide detector, a security camera, an attic humidity sensor, a garage door position sensor, a motion sensor, a door or window contact sensor, or other electronic or electrical components.

For instance, in certain embodiments, the functionality and/or operations may include forwarding the at least one transmission to a routing device, the routing device communicably coupled to the IoT device, and receiving may include monitoring a communication channel between the routing device and the IoT device and identifying the at least one transmission from the communication channel prior to receival by the routing device.

In some embodiments, determining at least one of the protocol, the command, or the data format of the IoT device is based at least on (i) a network packet structure, (ii) at least one communication header, or (iii) payload data of the at least one transmission, and providing the natural language response may be responsive to initiating the communication or querying a database including the status or configuration of the IoT device.

In certain arrangements, the one or more AI models include a large language model (LLM), and wherein the LLM include at least one of (i) a supervised learning model trained on labeled IoT device data or (ii) an unsupervised learning model trained on unlabeled IoT device data, and generating the natural language response to the natural language input using retrieval-augmented generation (RAG) may include retrieving the device dataset of the IoT device.

In some implementations, the device dataset is structured into a knowledge graph or vector space model compatible with performing RAG, and the RAG may include a ranking function for prioritizing retrieved device dataset from the device dataset based upon a relevance score between the retrieved device dataset and the received natural language input.

In certain embodiments, the functionality and/or operations may include creating a profile of a space or area within the local network including the device dataset of the IoT device or updating the profile of the space or area within the local network by storing the device dataset or updating the status, a usage, or the configuration of the IoT device.

Additionally or alternatively, initiating the communication may include pulling, in real-time, data corresponding to the status or configuration of the IoT device responsive to one or more queries transmitted to the IoT device according to the one or more interfacing commands.

Additionally or alternatively, initiating the communication may include pulling data corresponding to the status or configuration of the IoT device responsive to one or more queries transmitted to the IoT device according to the one or more interfacing commands and storing the pulled data in a database.

In another aspect, a computing or computer system may be provided for interfacing with a plurality of Internet of Things (IoT) devices within a local network using one or more artificial intelligence (AI) models. The modeling system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT bots, InstructGPT bots, Codex bots, Google Bard bots, and/or other electronic or electrical components, which may be in wired or wireless communication with one another, and which may employed as data input and/or output devices, data generation or collection devices, and/or data analysis presentation devices. For example, in one instance, the modeling system may include one or more memory devices having instructions stored thereon that, when executed by one or more processors, cause the one or more processors to perform operations including (1) determining at least one of a protocol, a command, or a data format of an IoT device; (2) generating and storing a device dataset including at least one of the protocol, the command, or the data format of the IoT device; (3) receiving, via a user interface, a natural language input corresponding to the IoT device; and/or (4) generating a response to the natural language input using retrieval-augmented generation (RAG) by: (4a) retrieving the device dataset of the IoT device; (4b) applying the retrieved device dataset and the natural language input as input to the one or more AI models to cause the one or more AI models to generate an output including one or more interfacing commands for initiating communications with the IoT device based upon at least one of the protocol, the command, or the data format of the IoT device; (4c) initiating a communication with the IoT device using the one or more interfacing commands; and/or (4d) providing or presenting, via the user interface, the response responsive to initiating the communication. The computer system may include additional, less, or alternate functionality and/or operations, including that discussed elsewhere herein.

For instance, in certain embodiments, the functionality and/or operations may include forwarding at least one transmission to a routing device, the routing device communicably coupled to the IoT device, and wherein receiving includes monitoring a communication channel between the routing device and the IoT device and identifying the at least one transmission from the communication channel prior to receival by the routing device.

In various implementations, determining at least one of the protocol, the command, or the data format of the IoT device is based at least on (i) a network packet structure, (ii) at least one communication header, and/or (iii) payload data of the at least one transmission.

In some embodiments, the one or more AI models include a large language model (LLM), and wherein the LLM include at least one of (i) a supervised learning model trained on labeled IoT device data or (ii) an unsupervised learning model trained on unlabeled IoT device data.

In various arrangements, the device dataset is structured into a knowledge graph or vector space model compatible with performing RAG, and wherein the RAG includes a ranking function for prioritizing retrieved device dataset from the device dataset based upon a relevance score between the retrieved device dataset and the received natural language input.

In certain embodiments, the functionality and/or operations may include creating a profile of a space or area within the local network including the device dataset of the IoT device or updating the profile of the space or area within the local network by storing the device dataset or updating a status, a usage, or a configuration of the IoT device.

In some embodiments, initiating the communication may include pulling, in real-time, data corresponding to a status or configuration of the IoT device responsive to one or more queries transmitted to the IoT device according to the one or more interfacing commands.

In some implementations, initiating the communication may include pulling data corresponding to a status or configuration of the IoT device responsive to one or more queries transmitted to the IoT device according to the one or more interfacing commands and storing the pulled data into a database.

In another aspect, a computer system may be provided for controlling a plurality of Internet of Things (IoT) devices within a local network using one or more artificial intelligence (AI) models. The modeling system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT bots, InstructGPT bots, Codex bots, Google Bard bots, and/or other electronic or electrical components, which may be in wired or wireless communication with one another, and which may be employed as data input and/or output devices, data generation or collection devices, and/or data analysis presentation devices. For example, in one instance, the modeling system may include one or more memory devices having instructions stored thereon that, when executed by one or more processors, cause the one or more processors to perform operations including (1) receiving at least one data transmission of an IoT device of a plurality of IoT devices connected within the local network; (2) determining, using the received at least one data transmission, at least one of a protocol, a command, or a data format of the IoT device; (3) generating and storing a device dataset including at least one of the protocol, the command, or the data format of the IoT device; (4) receiving, via a user interface, a natural language input corresponding to controlling or configuring the IoT device; and/or (5) generating a response to the natural language input using retrieval-augmented generation (RAG) by: (5a) retrieving the device dataset of the IoT device; (5b) applying the retrieved device dataset and the natural language input as input to the one or more AI models to cause the one or more AI models to generate an output including (i) a natural language response regarding a status or configuration of the IoT device and/or (ii) one or more executable commands for controlling the IoT device based upon at least one of the protocol, the command, or the data format of the IoT device; (5c) configuring the IoT device by performing a command sequence using the one or more executable commands to update a parameter or control of the IoT device; and/or (5d) providing, via the user interface, the natural language response including the status or configuration of the IoT device responsive to the configuring. The computer system may include additional, less, or alternate functionality and/or operations, including that discussed elsewhere herein.

In certain embodiments, the one or more executable commands may include executable code that, when executed, controls, configures, or transmits feedback to the IoT device or another connected device within the local network based upon a communication interface and a command format supported by the IoT device or the another connected device.

Advantages will become more apparent to those skilled in the art from the following description of embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers indicate identical, functionally similar, and/or structurally similar elements.

These are shown in the drawings arrangements which are presently discussed, it being understood, however, that the present embodiments are not limited to the precise arrangements and are instrumentalities shown, wherein:

FIG. 1 is a block diagram of an exemplary modeling system, according to some embodiments.

FIG. 2A is a flow diagram of an exemplary computer-implemented or computer-based process of interfacing with a plurality of IoT devices, according to some embodiments.

FIG. 2B is another flow diagram of an exemplary computer-implemented or computer-based process of interfacing with a plurality of IoT devices, according to some embodiments.

FIG. 3 is an exemplary sequence of interactions between a user and a modeling system, according to some embodiments.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The present embodiments relate to, inter alia, a computer system for managing and controlling a plurality of Internet of Things (IoT) devices within a local or commercial network. For instance, a plurality of IoT devices (e.g., sensors, security systems, HVAC units, sump pumps, water heaters) may communicate with a central system and/or the central system may intercept communications that collect data from IoT devices, process the data, and provide control and status updates through an interface.

These IoT devices may include residential devices and/or commercial building systems (e.g., sump pumps, water heaters, HVAC units, refrigerators, lighting systems, garage door openers, door/window sensors, smoke detectors, carbon monoxide detectors, motion sensors, security cameras, lighting, motion detectors, humidity sensors, indoor air quality (IAQ) sensors, elevators, HVAC controls, access control systems, fire suppression systems, occupancy sensors, or any other home automation device and/or commercial building management device). The system may generate device datasets and receive natural language inputs from users to facilitate the generation of natural language responses or control commands.

For example, a commercial building or home may include a plurality of IoT devices, such as lighting systems, HVAC units, sump pump sensors, water heater monitors, motion detectors, security cameras, indoor air quality sensors, smart thermostats, access control systems, fire alarms, and/or other electronics or electrical components and devices. These devices may send transmissions corresponding to sensor data or operational states (e.g., water level in sump pump, temperature of water heater, status of HVAC system). The system may analyze these transmissions to generate device datasets (e.g., a protocol, a command, or a data format). That is, the device datasets may include sensor data and operational states and also include communication histories and device configuration settings.

In some arrangements, the device datasets may be retrieved responsive to modeling a natural language input of the user. For example, a user may send a natural language input about a sump pump, such as “What is the current water level in the sump pump?” In this example, the system may model the input and output a natural language response providing the water level. In another example, a user may send a natural language input about a water heater, such as “Is the water heater operating at optimal temperature?” In this example, the system may process the input and output a natural language response indicating the current temperature and whether it is within optimal operating range. In yet another example, a user may send a natural language input about an HVAC system, such as “Is the air quality safe?” In this example, the system may process the input and output an interfacing command to retrieve air quality sensor data and generate a natural language response indicating the air quality status.

A generative AI model may be trained using historical data from IoT devices, such as protocols, commands, and/or data formats of IoT devices. The system may then receive natural language inputs to perform modeling by retrieving device datasets and generating interfacing commands. For instance, the user may provide a natural language input such as “Does the HVAC filter need to be changed?” In this instance, the system may apply a device dataset of the IoT device and the natural language input as input to an AI model to cause the one or more AI models to generate an output (e.g., status or configuration, such as filter usage data and maintenance recommendations).

In another instance, the user may provide a natural language input such as “Turn off all lights in the office building.” In this instance, the system may apply a device dataset of the IoT device and the natural language input as input to an AI model to cause the one or more AI models to generate an output (e.g., control command for turning off the lights, confirmation of action, other control commands, etc.).

In some implementations, the model output may include one or more interfacing commands for initiating communications with the IoT device based upon at least one of the protocol, the command, or the data format of the IoT device. In some implementations, the output may include one or more executable commands for controlling the IoT device based upon at least one of the protocol, the command, or the data format of the IoT device. Responsive to applying a retrieved device dataset and the natural language input, the systems and methods may communicate with the IoT device and/or configure the IoT device and provide a natural language response including a status or configuration of the IoT device.

In one aspect, a computer-implemented method of interfacing with IoT devices may include, via one or more processors, transceivers, sensors, servers, memory units, computing devices, etc. (1) receiving at least one transmission of an IoT device of a plurality of IoT devices connected within the local network; (2) determining, using the at least one transmission, at least one of a protocol, a command, or a data format of the IoT device; (3) generating and storing a device dataset including at least one of the protocol, the command, or the data format of the IoT device; (4) receiving, via a user interface, a natural language input corresponding to the IoT device; and/or (5) generating a natural language response to the natural language input using retrieval-augmented generation (RAG) by (5a) applying the device dataset and the natural language input as input to the one or more AI models to cause the one or more AI models to generate an output including one or more interfacing commands for initiating communications with the IoT device based upon at least one of the protocol, the command, or the data format of the IoT device; (5b) initiating a communication with the IoT device using the one or more interfacing commands to obtain a status or configuration of the IoT device; and/or (5c) providing, via the user interface, the natural language response including the status or configuration of the IoT device.

In another aspect, a computer-implemented method of interfacing with IoT devices in the method may include, via one or more processors, transceivers, sensors, servers, memory units, computing devices, etc. (1) receiving at least one data transmission of an IoT device of a plurality of IoT devices connected within the local network; (2) determining, using the received at least one data transmission, at least one of a protocol, a command, or a data format of the IoT device; (3) generating and storing a device dataset including at least one of the protocol, the command, or the data format of the IoT device; (4) receiving, via a user interface, a natural language input corresponding to controlling or configuring the IoT device; and/or (5) generating a response to the natural language input using retrieval-augmented generation (RAG) by (5a) retrieving the device dataset of the IoT device; (5b) applying the retrieved device dataset and the natural language input as input to the one or more AI models to cause the one or more AI models to generate an output including (i) a natural language response regarding a status or configuration of the IoT device and/or (ii) one or more executable commands for controlling the IoT device based upon at least one of the protocol, the command, or the data format of the IoT device; (5c) configuring the IoT device by performing a command sequence using the one or more executable commands to update a parameter or control of the IoT device; and/or (5d) providing, via the user interface, the natural language response including the status or configuration of the IoT device responsive to the configuring.

Additionally, users and businesses may have several IoT devices scattered across their homes or buildings, each one coming with its own applications and/or specifications. The AI models implemented herein may, in some implementations, provide an LLM to create a chat type interface that users may get all the info for their various devices. For example, the application may control and/or get (or obtain) information with natural language. The systems and methods described may, in certain implementations, provide a router system with models that users may connect one or more IoT devices in their homes. In some implementations, the router system may be a man-in-the-middle (MITM) and upload the device readings and info into a LLM recognized data source (e.g., vector database). The router system may include an LLM that may use RAG techniques to consume the sensor and IoT data, and would grant users an easy way to chat. Additionally, the AI models may use agents to create functions or codes that allow users to convert text into things their devices may do. For example, a user may provide “please create a system that turns off the lights at 9 pm.” In this example, an LLM-agent may provide code and creates one or more function. The functions may be imported into LLM models and custom code, for example, by use of a custom router system to connect (one or more) IoT devices paired with one or more LLMs to allow users to interact with these IoT devices and sensors.

### Overview

Referring to the Figures, computer systems and computer-implemented methods for managing and/or controlling a plurality of Internet of Things (IoT) devices within a local network may be provided. For example, the computer system may be configured to receive a plurality of transmissions associated with IoT devices (e.g., sensors, appliances, connected devices, security systems). The computer system may process these transmissions to manage device communication, control operations, and/or provide status updates (e.g., real-time updates) to users through one or more natural language interfaces. The system may also allow users to issue commands and receive feedback through the interface, which processes user inputs to generate corresponding device control actions and/or statuses.

Using the device transmissions, the computer systems and computer-implemented methods may generate interfacing commands for one or more devices within the local network. For instance, the system may identify communication protocols, device types, and command formats to facilitate communication. The interfacing system, responsive to a natural language input, may generate outputs using one or more AI models, such as control commands, device status updates, or scheduled actions based upon the transmissions. These outputs may be presented to the users via the interface, as a natural language output (such as presented via a chatbot or voice bot running on a mobile or other computing device), allowing for interaction and real-time statuses and control of the connected IoT devices.

In certain embodiments, updates to device control parameters (e.g., performing a command sequence using the one or more executable commands to update a parameter or control of the IoT device) may be performed based upon the analysis of device transmissions and the model outputs generated by the system. Advantageously, the computer systems and computer-implemented methods described herein may improve the efficiency and responsiveness of IoT device management by processing and managing device data from multiple sources within a local network (e.g., residential homes, small offices, apartments, or other domiciles), a commercial network (e.g., office buildings, industrial facilities, retail stores), and/or a semi-commercial network (e.g., large residential complexes, multi-unit buildings, shared workspaces).

The computer systems and computer-implemented methods have facilitated advancements in managing and controlling a wide variety of IoT devices. The outputs, including control commands, statuses, and alerts, may be presented to users through interactive interfaces, which may provide users with actionable (e.g., human-readable) information and real-time feedback on the performance of their IoT devices. For example, a residential or commercial building may utilize various IoT devices, such as environmental sensors, security cameras, lighting systems, and household appliances. Similarly, industrial facilities may employ IoT systems for monitoring machinery, detecting environmental conditions, and managing facility security.

Similarly, managing IoT device data using the computer systems and computer-implemented methods described herein may provide more efficient utilization of computational resources. For instance, by processing natural language inputs for a variety of IoT devices, the system may reduce device interactions and minimize redundant communications. This may include allocating resources dynamically for real-time device status updates and command processing. By leveraging AI models and device datasets, the system may facilitate the allocation of computing resources, leading to optimized device management. That is, users may monitor and manage their devices by providing natural language inputs through the interactive interface.

Furthermore, managing IoT device data may facilitate improved response to operational issues by identifying status updates and alerts that would otherwise remain undetected. For instance, the computer systems and computer-implemented methods may process transmissions from sensors, security devices, and appliances to generate a device dataset associated with at least one protocol, command, or data format of the IoT device. Responsive to receiving a natural language input from the user, the system may generate natural language responses. The generation of natural language responses may include applying the device dataset and a natural language input to generate an output including one or more interfacing commands for initiating communications with the IoT devices. The initiated communications (e.g., to obtain a status or configuration of the IoT device and/or perform a command sequence using executable commands) may improve device management by allowing for interactions between the system and connected devices.

In addition to improving device management efficiency, managing IoT device transmissions may provide additional insights into device performance and control behavior. While traditional systems may relate to predefined control settings or manual commands, integrating data from multiple IoT devices allows for a more adaptable control system. The system may also provide users with status reports and actionable feedback through the user interface. As such, it is advantageous to have a computer system capable of processing and managing various device transmissions to optimize the performance of IoT networks and/or structure (e.g., house, apartment, building, skyscraper, manufacturing facility).

Advantageously, one aspect of the computer systems and computer-implemented methods described herein may enhance the process for managing and configuring IoT devices. For example, by assessing transmissions related to sensors, security devices, and appliances (including smart appliances), the computer systems and computer-implemented methods may determine protocols, commands, or data formats of the IoT devices to store a device dataset for future retrieval when generating a natural language response to a natural language input of a user. These determinations and generations of a device dataset may improve device control accuracy, improving system reliability and responsiveness.

Similarly, by assessing IoT device data from various sources and storing the data into device dataset(s), the computer systems and computer-implemented methods described herein may generate natural language outputs that inform updates to be performed (e.g., new control protocols, optimized communication settings, improved automation sequences). This may include identifying recurring device issues, emerging operational risks, and opportunities for improving system efficiency responsive to natural language inputs. That is, the model outputs (e.g., including a natural language response, interfacing commands for initiating communications with the IoT device and/or executable commands for controlling the IoT devices based upon a protocol, command, or data format of the IoT device) may improve IoT device performance by facilitating faster and more informed decisions regarding device management.

Advantageously, one aspect of the computer systems and computer-implemented methods described herein may allow users to interact with multiple IoT devices using natural language inputs. For instance, by providing real-time feedback and control options, the computer systems and computer-implemented methods may enhance user experience and system efficiency. The interactive interface may facilitate dynamic monitoring and control, leading to increased operational efficiency and improved device responsiveness.

### Exemplary Interfacing System With Modeling System

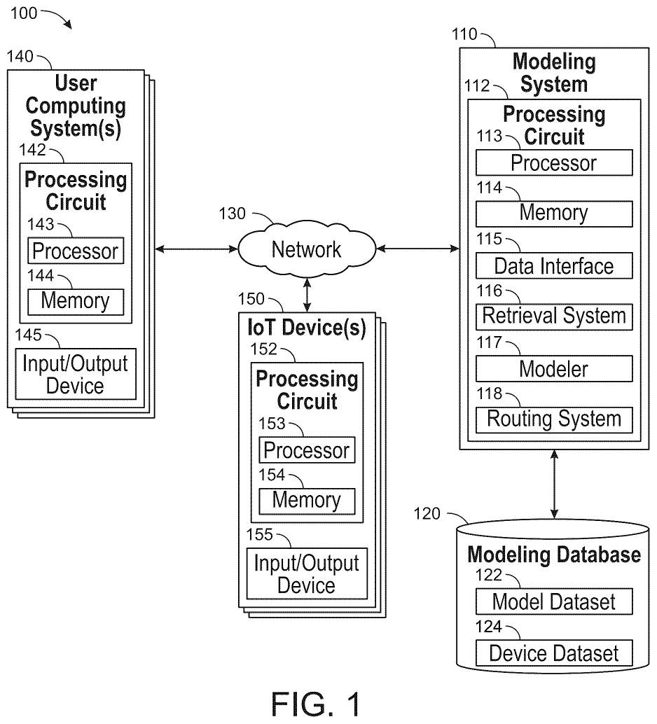

Referring to FIG. 1, a block diagram of an exemplary interfacing system, shown as interfacing system 100, is shown, according to some embodiments. The interfacing system 100 may include a modeling system, shown as modeling system 110, having a processing circuit 112, processor 113, memory 114, data interface 115, retrieval system 116, modeler 117, and routing system 118.

The interfacing system 100 may also include a modeling database 120 having a model dataset 122 and a device dataset 124. The interfacing system 100 may also include a user computing system, shown as user computing system 140, having a processing circuit 142, processor 143, memory 144, and input/output device 145. The interfacing system 100 may also include IoT device(s), shown as IoT devices(s) 150, having a processing circuit 152, processor 153, memory 154, and input/output device 155.

The components of the interfacing system 100 may be connected, or in wired or wireless communication, via a network 130. It should be noted that the number and type of components shown is merely illustrative and, in various implementations, implementations of the interfacing system 100 may have additional, fewer, and/or different components than those illustrated in FIG. 1 including, those mentioned elsewhere herein.

The components of the interfacing system 100 may be connected, or in communication, via a network 130. Network 130 may include computer networks such as the Internet, local, wide, metro or other area networks, intranets, satellite networks, other computer networks such as voice or data mobile phone communication networks, combinations thereof, or any other type of electronic communications network. Network 130 may include or constitute a display network. In some implementations, network 130 facilitates secure communication between components of interfacing system 100.

As a non-limiting example, network 130 may implement transport layer security (TLS), secure sockets layer (SSL), hypertext transfer protocol secure (HTTPS), and/or any other secure communication protocol. It should be noted that the number and type of components shown are merely illustrative, and in various embodiments, implementations of the interfacing system 100 may have additional, fewer, and/or different components than those illustrated in FIG. 1.

The network 130 may facilitate communication between various nodes, such as the modeling system 110, the user computing system 140, the IoT device(s) 150, and the modeling database 120. In some implementations, data flows through the network 130 from a source node to a destination node as a flow of data packets, e.g., in the form of data packets in accordance with the Open Systems Interconnection (OSI) layers. A flow of packets may use, for example, an OSI layer-4 transport protocol such as the User Datagram Protocol (UDP), the Transmission Control Protocol (TCP), or the Stream Control Transmission Protocol (SCTP), transmitted via the network 130 layered over an OSI layer-3 network protocol such as Internet Protocol (IP), e.g., IPv4 or IPv6.

The network 130 may be composed of various network devices (nodes) that are communicatively linked to form one or more data communication paths between participating devices. Each networked device may include at least one network interface for receiving and/or transmitting data, typically as one or more data packets. An illustrative network 130 is the Internet; however, other networks may be used. The network 130 may be an autonomous system (AS), i.e., a network that may be operated under a consistent unified routing policy (or at least appears to be from outside the AS network) and generally managed by a single administrative entity (e.g., a system operator, administrator, or administrative group).

Generally, the modeling system 110, user computing system 140, IoT devices 150, and modeling database 120 may include one or more logic devices, which may be one or more computing devices equipped with one or more processing circuits (e.g., processing circuit(s) 112, processing circuit(s) 142, and/or processing circuit(s) 152) that run instructions stored in a memory device (e.g., memory 114, memory 144, and/or memory 154) to perform various operations. The processing circuit may be made up of various components such as a microprocessor, an ASIC, or an FPGA, and the memory device may be any type of storage or transmission device capable of providing program instructions.

The instructions may include code from various programming languages commonly used in the industry, such as high-level programming languages, web development languages, and system programming languages. The modeling system 110, user computing system 140, and IoT devices 150 may also include one or more databases for storing data, such as modeling database 120, that receive and provide data to other systems and devices on the network 130.

Each system or device in interfacing system 100 may include one or more processors, memories, network interfaces (sometimes referred to herein as a “network circuit”) and user interfaces. The memory (e.g., memory 114, memory 144, and/or memory 154) may store programming logic that, when executed by the processor (e.g., processor(s) 113, processor(s) 143, and/or processor(s) 153) controls the operation of the corresponding computing system or device. The memory may also store data in databases. For instance, memory 114 may store programming logic that, when executed by processor 113 within processing circuit 112, causes modeling database 120 to update IoT device information in device dataset 124.

The network interfaces may allow the computing systems and devices to communicate wirelessly or otherwise. The various components of devices in interfacing system 100 may be implemented via hardware (e.g., circuitry), software (e.g., executable code), or any combination thereof. Devices, systems, and components in FIG. 1 may be added, deleted, integrated, separated, and/or rearranged in various embodiments of the disclosure.

As will be discussed in greater detail below, the modeling system 110 may be configured to receive at least one transmission of an IoT device 150 of a plurality of IoT devices connected within the local network. For example, a transmission may correspond to device status data (e.g., sensor readings, control signals, device commands, notifications, etc.). In some implementations, the IoT device 150 may be any home automation device and the input/output device 155 may transmit or receive control commands. In various implementations, the IoT device 150 may be a sensor or actuator, and the input/output device 155 may display or adjust settings. Additionally, the plurality of Internet of Things (IoT) devices may be within a local network (e.g., Wi-Fi, Zigbee, Bluetooth) of a residential building (e.g., home, apartment, condo).

The modeling system 110 may also be configured to determine, using the at least one transmission, at least one of a protocol, a command, or a data format of the IoT device. The protocol may be Zigbee, Z-Wave, Wi-Fi, Bluetooth, Ethernet, or any other communication protocol. The command may be to start, stop, adjust, monitor, trigger, or any other functional command. The data format may be JSON, XML, binary, plain text, or any structured data format. In some implementations, determining at least one of the protocol, the command, or the data format of the IoT device 150 may be based upon the modeling system 110 determining a network packet structure (e.g., TCP, UDP, MQTT, CoAP), at least one communication header (e.g., IP address, port number, packet length, sequence number), or payload data (e.g., sensor values, operational states, control actions) of the at least one data transmission.

The modeling system 110 may also be configured to generate and store a device dataset 124 including at least one of the protocol, the command, or the data format of the IoT device. That is, the modeling system 110 may store device-specific communication patterns, configurations, and state information. For example, the device dataset 124 may include protocol mappings, command histories, and device states. In some implementations, the device dataset may be structured into a knowledge graph or vector space model compatible with performing retrieval-augmented generation (RAG). That is, the knowledge graph or vector space may facilitate retrieval and organization of IoT device-related data. For example, a knowledge graph may include device relationships and dependencies and may be structured to facilitate the modeling of device interactions (e.g., in the local network). In another example, a vector space model may include device attributes and characteristics and may be structured to facilitate similarity-based queries.

The modeling system 110 may also be configured to receive, via a user interface, a natural language input corresponding to the IoT device. For instance, the user interface may be a text-based or voice-activated interface. The user computing system 140 may provide or otherwise present the user interface to facilitate device control or status inquiry. For example, the user interface may display a text input field or voice command option. In this example, the natural language input may be a command or query related to the functionality of an IoT device.

Additionally, the natural language input may relate and/or correspond with an IoT device 150 such that the modeling system 110 interprets and processes the input accordingly. For example, the natural language input may be a request to turn on or off a device or to obtain status information. In some implementations, the natural language input may include a request to obtain sensor information or control a sensor of an IoT device 150. For instance, the input may be a query for a maintenance schedule and/or temperature or humidity readings. In another instance, the input may request the activation or deactivation of a connected device.

In some implementations, the sensor (e.g., IoT device 150) monitoring the subsystem may include at least one of a sump pump sensor, a water heater sensor, an HVAC sensor, a smoke detector, a carbon monoxide detector, a security camera, an attic humidity sensor, a garage door position sensor, a motion sensor, a door or window contact sensor, an odor sensor, a water sensor, a moisture sensor, a mildew sensor, and/or other electronic or electrical components, sensors, or devices. That is, the modeling system 110 may collect data from various types of sensors deployed throughout the local network. Additionally, the sensor monitoring the subsystem may include at least one of a vibration sensor, pressure sensor, light sensor, air quality sensor, occupancy sensor, water sensor, moisture sensor, humidity sensor, or other sensor types associated with a building or commercial structure.

In some arrangements, the RAG may include a ranking function (e.g., cosine similarity, nearest neighbor, TF-IDF, or any machine learning-based function) for prioritizing retrieved device dataset from the device dataset 124 based upon a relevance score between the retrieved device dataset and a received natural language input. The relevance score may be generated based upon similarities, context, or historical usage data. For instance, the relevance score may be based upon the frequency of commands or past user interactions with the IoT device. In this example, the ranking function may be used to prioritize commands that are more frequently or recently used.

The modeling system 110 may also be configured to generate a natural language response to the natural language input using retrieval-augmented generation (RAG). Referring to the natural language response generally, oftentimes homeowners, building owners, or building operators may interact with a plurality of IoT devices 150. However, managing these devices with diverse communication protocols and interfaces may be complex. That is, the modeling system 110 improves the process by allowing users to interact with multiple devices using natural language inputs. As described in various embodiments herein, the modeling system 110 may interpret the input of the user, generate a corresponding response, and initiate the actions on the IoT devices 150.

To generate a natural language response, the modeling system 110 may apply the device dataset and the natural language input as input to the one or more AI models to cause the one or more AI models to generate an output including one or more interfacing commands (e.g., start, stop, configure, query status, adjust settings, etc.). The interfacing commands may be configured to and/or used for initiating communications with an IoT device 150 based upon at least one of the protocol, the command, or the data format of the IoT device. That is, the commands generated by the AI model may be customized to the specific communication protocol or device configuration. For instance, the interfacing commands may be sent to the IoT device to trigger an action or retrieve device status.

The one or more AI models may include a large language model (LLM). The LLM may include at least one of (i) a supervised learning model trained on labeled IoT device data (e.g., device states, commands, sensor data) or (ii) an unsupervised learning model trained on unlabeled IoT device data (e.g., raw network traffic, device logs, communication patterns). Additionally, generating the natural language response to the natural language input may include using retrieval-augmented generation (RAG) including retrieving the device dataset 124 of the IoT device 150. For example, the modeling system 110 may use the retrieved device dataset to generate commands based upon historical data or specific device configurations.

To generate a natural language response, the modeling system 110 may also initiate a communication with the IoT device using the one or more interfacing commands to obtain a status or configuration of the IoT device. In some implementations, the status or configuration of the IoT device 150 may include sensor information corresponding to a sensor monitoring a subsystem of the residential building. That is, the communication may retrieve real-time sensor data or configuration settings. For instance, the status may include current temperature, power state, or operational mode. In some arrangements, the modeling system 110 may also initiate a communication with the IoT device using the one or more interfacing commands. For example, the modeling system 110 may send a command to adjust settings or perform diagnostics.

In some embodiments, initiating the communication may include pulling (e.g., in real-time or in near real-time) data corresponding to the status or configuration of the IoT device 150 responsive to one or more queries transmitted to the IoT device 150 according to the one or more interfacing commands (e.g., status request, configuration query, sensor readout, or any other relevant request). That is, the queries may be device-specific and retrieve relevant operational data. For example, pulling may include retrieving maintenance or operational data (e.g., battery backup status) from a sump pump, water heater, smart appliance(s), smart furnace or air conditioning unit, smart manufacturing materials (e.g., smart windows, smart shingles, smart siding, etc.), smart sensors, etc. In another instance, pulling may include retrieving motion detection logs from a security system, or security sensors or cameras.

In various embodiments, initiating the communication may include pulling data corresponding to the status or configuration of the IoT device 150 responsive to one or more queries transmitted to the IoT device 150 according to the one or more interfacing commands. That is, instead of in real-time or near real-time, the modeling system 110 may store the pulled data in a modeling database 120, such as in device dataset 124. For example, pulling may include retrieving historical usage data or device configuration snapshots. In another instance, pulling may include retrieving aggregated sensor data from multiple IoT devices.

To generate a natural language response, the modeling system 110 may also provide (e.g., via the user interface of the user computing system 140) the natural language response including the status or configuration of the IoT device 150. That is, the user interface of the user computing system 140 may be an interactive platform such that users may view and control devices. For example, the natural language response may include device-specific information (e.g., status of the IoT device 150). In another instance, the natural language response may include configuration settings (e.g., configuration of the IoT device 150). Additionally, providing the natural language response may be responsive to initiating the communication (e.g., querying for status, adjusting settings) or querying a database (e.g., device logs, status history) including the status or configuration of the IoT device. In some arrangements, the modeling system 110 may also provide, via the user interface, a response responsive to initiating the communication. For instance, the modeling system 110 may update the user on a state or activity of the IoT device 150.

In some arrangements, to generate a response to the natural language input, the modeling system 110 may apply the retrieved device dataset (e.g., device dataset 124) and the natural language input as input to the one or more AI models to cause the one or more AI models to generate an output. The output may include (i) a natural language response regarding a status or configuration of the IoT device and (ii) one or more executable commands for controlling the IoT device based upon at least one of the protocol, the command, or the data format of the IoT device. That is, the natural language response may be dynamically generated (e.g., providing status, settings, control options, etc.) and the executable commands may be transmitted to the IoT device 150 (e.g., performing one or more operations, such as, but not limited to, turning on/off, adjusting settings, activating devices, monitoring sensor data, resetting device configurations, initiating diagnostics, logging operational data, and/or adjusting automation rules).

Furthermore, the modeling system 110 may also be configured to configure the IoT device 150 by performing a command sequence using the one or more executable commands to update a parameter or control of the IoT device 150. That is, the command sequence may include sending various control instructions to the IoT device 150 based upon user inputs and/or model output. The one or more executable commands may include executable code that, when executed, controls (e.g., activating sump pump systems, adjusting water heater settings, modifying HVAC operation, testing smoke detectors, resetting carbon monoxide detectors, adjusting security camera angles, monitoring attic humidity levels, controlling garage door position, or toggling motion sensors and door/window contact sensors), configures (e.g., setting sensor thresholds, updating security camera recording schedules, configuring HVAC temperature ranges, setting water heater timers, adjusting sump pump activation levels, modifying smoke detector sensitivity, changing carbon monoxide detector alarm settings, or setting motion sensor detection ranges), or transmits feedback (e.g., reporting sump pump activity, providing water heater status, sending HVAC system diagnostics, alerting on smoke detector test results, transmitting carbon monoxide detector readings, sending security camera footage, reporting attic humidity levels, or sending garage door position updates) to the IoT device 150 or another connected device (e.g., a linked IoT device, sensor array, etc.) within the local network based upon a communication interface and a command format supported by the IoT device 150 or the other connected device. Additionally, the command format may be device-specific. For instance, different IoT devices 150 may operate with different command structures based upon the specifications of the manufacturer or third-party.

In certain embodiments, the executable command may be any functional instruction (e.g., start, stop, adjust, activate, deactivate, reset, configure, monitor) and may be used by the modeling system 110 to manage the devices within the local network. In this instance, the modeling system 110 facilitates control over the IoT devices 150 based upon user input, model output, and/or automated processes. In various embodiments, the modeling system 110 may also be configured to provide (e.g., to the user computing system 140 via a user interface) the natural language response including the status (e.g., operational state, sensor readings, activity logs) or configuration (e.g., device settings, performance parameters) of the IoT device 150 responsive to the configuring. That is, the modeling system 110 may generate responses based upon real-time or historical data. For instance, the user may query the system for the latest status or request modifications to the operations of an IoT device 150.

Generally, the modeling system 110 may be configured to interface with a plurality of Internet of Things (IoT) devices 150 within a local network of a residential building (or commercial facility, or multi-unit complex) using one or more artificial intelligence (AI) models. That is, the modeling system 110 may process data from various IoT devices to provide real-time status updates and control capabilities. For example, the modeling system 110 may generate control commands or retrieve device data based upon user inputs. In some implementations, the modeling system 110 may control a plurality of IoT devices 150 within a local network using artificial intelligence (AI) models.

In some embodiments, the data interface 115 may be configured to receive at least one transmission of an IoT device 150 of a plurality of IoT devices connected within the local network. That is, the data interface 115 may intercept and interpret communications between IoT devices 150 and the local network. For instance, the transmission may be a sensor update or an operation. In another instance, the transmission may be a control command sent from a user to the IoT device 150. In yet another instance, the transmission may be intercepted between the IoT device 150 and a router. That is, catch and release may be performed by the data interface 115 such that the data interface 115 captures the data before forwarding it. In some implementations, the data interface 115 may facilitate the receival by querying the IoT device 150 for status updates.

In various embodiments, the data interface 115 may be configured to determine, using the at least one transmission, at least one of a protocol, a command, or a data format of the IoT device. That is, the data interface 115 may analyze the transmission to extract relevant control or status information. For example, the protocol may be any standard IoT communication protocol, such as, but not limited to, Zigbee, Z-Wave, and/or Bluetooth. In another example, a command may be any device operation command, such as, but not limited to, start, stop, configure, reset, update, and/or report. In yet another example, a data format may be any structured format, such as, but not limited to, JSON, XML, CSV, binary, and/or encrypted payloads. In some implementations, the data interface 115 may facilitate the determination by parsing network packet data to identify relevant control commands.

In certain arrangements, the data interface 115 may forward at least one data transmission to a routing device (e.g., gateway, switch, firewall, cloud service). That is, the data interface 115 may act as a mediator for communication between the IoT device 150 and the broader network. The routing device may be communicably coupled (e.g., via wired connections, wireless communication, and/or LAN) to the IoT device 150. Additionally, receiving may include monitoring a communication channel (e.g., Wi-Fi, Ethernet, cellular, and/or any network protocol—on or off network 130) between the routing device and the IoT device 150 and identifying the at least one data transmission from the communication channel prior to receival by the routing device. For example, the data interface 115 may analyze data packets for device-specific headers. In another example, the data interface 115 may capture diagnostic information from the transmission.

Additionally, to determine at least one of the protocol, the command, or the data format of the IoT device 150, the data interface 115 may identify (i) a network packet structure, (ii) at least one communication header, or (iii) payload data of the at least one data transmission. For instance, a network packet structure may be any IoT-specific structure, such as, but not limited to, frames, segments, and/or datagrams. In this instance, the data interface 115 may identify the network packet structure by analyzing transport-layer details. In another instance, a communication header may be any protocol header, such as, but not limited to, IP headers, MAC addresses, and/or device IDs. In this instance, the data interface 115 may identify the communication header by extracting the first few bytes of the packet.

In yet another instance, a payload data may be any sensor reading, status information, or control message, such as, but not limited to, temperature readings, motion detection alerts, and/or status flags. In this instance, the data interface 115 may identify the payload data by decoding the transmission format.

In various embodiments, the IoT device(s) 150 may provide data transmissions and/or status updates to the modeling system 110. For instance, the data interface 115 may query or otherwise access the IoT device 150 to retrieve operational and configuration data. In another instance, the data interface 115 may receive and/or intercept transmissions by the IoT device 150 on the local network (e.g., LAN network of a residential home). As used herein, “local network” may refer to any network infrastructure within a confined space, such as a home, building, or office. In some implementations, the IoT device 150 may provide a data feed (e.g., real-time, near real-time, periodic, accessible) to the modeling system 110 such that the transmissions may be monitored and analyzed.

In certain embodiments, the retrieval system 116 may be configured to generate and store a device dataset 124 including protocols, commands, and/or data formats of the IoT devices 150. That is, generating the device dataset to store in device dataset 124 may include extracting and organizing data from IoT transmissions. For instance, the retrieval system 116 may generate records for operational parameters of each IoT device 150. In this instance, the device dataset 124 may include communication logs, control histories, and sensor readings. The modeling database 120 may include a plurality of device datasets 124 for various devices within a network. That is, the modeling database 120 may include a device dataset 124 for each IoT device 150 on the local network and/or broader networked systems. For example, the database may store configurations and event logs for each IoT device within a building management system.

Additionally, storing the device dataset 124 in modeling database 120 may include indexing the data for retrieval. For instance, the retrieval system 116 may store device attributes such as protocols and command structures in a RAG format and/or searchable format. In this instance, storing may include creating metadata tags for access. The plurality of device datasets 124 may be structured into a knowledge graph or vector space model compatible with performing RAG.

In various implementations, the retrieval system 116 may also be configured to receive, via a user interface, a natural language input corresponding to the IoT device. For instance, the natural language input may include a request to obtain the sensor information or control the sensor. The user interface may be provided in an application on the user computing system 140 (e.g., presented on a display of an input/output device 145) and/or directly on the IoT device 150 (e.g., presented on a display of an input/output device 155).

That is, the natural language input may be received by the retrieval system 116 from a user computing system 140 or from a control panel. For example, the retrieval system 116 may receive a voice command (or audio command, or video command from facial or hand movements) through a voice-controlled assistant. I

n this example, the natural language input may be inputted at the user computing system 140 and transmitted over network 130 to the retrieval system 116. For example, the retrieval system 116 may receive a command through a touchscreen interface. In this example, the natural language input may be inputted at the IoT device 150 and transmitted over network 130 to the retrieval system 116.

In some implementations, the modeler 117 may be configured to generate a natural language response to the natural language input using retrieval-augmented generation (RAG). Generally, generating the natural language response may include (1) applying the device dataset (e.g., retrieved responsive to the natural language input) and the natural language input as input to the one or more AI models to cause (e.g., device control, status update, operational command) the one or more AI models to generate an output, (2) initiating a communication with the IoT device 150, and/or (3) providing, via the user interface, the natural language response. That is, the output may include one or more interfacing commands for initiating communications with the IoT device 150 based upon at least one of the protocol, the command, or the data format of the IoT device 150. In various implementations, the output may include a natural language response regarding a status or configuration of the IoT device 150 and one or more executable commands (e.g., power cycle, reset, sensor calibration, scheduling, etc.) for controlling the IoT device 150 based upon at least one of the protocol, the command, or the data format of the IoT device.

Additionally, the modeler 117 may initiate a communication with the IoT device 150 using the one or more interfacing commands to obtain a status or configuration of the IoT device 150 (e.g., battery level, connectivity status, operational mode). In various embodiments, the modeler 117 may configure the IoT device by performing a command sequence (e.g., adjust settings, modify configuration, execute operational instructions) using the one or more executable commands to update a parameter or control of the IoT device 150. Further, the modeler 117 may provide (e.g., via a user interface) the natural language response including the status or configuration of the IoT device.

In various implementations, the retrieval system 116 may be configured to retrieve one or more device datasets of corresponding IoT devices 150. That is, responsive to receiving a natural language input, the retrieval system 116 may facilitate retrieval of the device dataset used in modeling by the modeler 117. That is, RAG may be employed to retrieve specific data for generating responses. For example, the retrieval system 116 may prioritize the most relevant dataset for a command input regarding device status.

In certain arrangements, the RAG may correspond to a ranking function for prioritizing retrieved device datasets from the device dataset based upon a relevance score (e.g., device history, recent activity, command context) between the retrieved device dataset and the received natural language input. Additionally, generating the natural language response to the natural language input using retrieval-augmented generation (RAG) may include the retrieval system 116 querying the device dataset 124 of the IoT device 150. In particular, this may include pulling operational data to support a response. For instance, the retrieval system 116 may pull sensor data from a water heater or operational logs from a security system.

In some embodiments, the modeler 117 may be configured to apply the retrieved device dataset and a natural language input to the one or more AI models. Applying the retrieved device dataset and a natural language input as the input to the one or more AI models may include transforming the device dataset and natural language input into a plurality of feature vectors. For example, the feature vectors may be numerical representations of data attributes extracted from the corresponding protocols, commands, and/or data formats in the device dataset. Additionally or alternatively, the status of a device's operational mode may be transformed into a feature vector [0.5, 0.8, 0.9] where each number represents a different aspect of the state of the IoT device 150. In this example, 0.5 may correspond to power status, 0.8 may correspond to network connectivity, and 0.9 may correspond to operational temperature. That is, transforming may include the modeler 117 converting natural language data (e.g., textual data) and device data into structured numerical data.

Generally, applying the device dataset 124 and the natural language input may cause the AI models to generate an output including one or more interfacing commands for initiating communications with the IoT device 150 based upon at least one of the protocol, the command, or the data format of the IoT device 150. That is, the interfacing commands may be power cycle, restart, firmware update, modify configuration, execute diagnostic, and/or any custom operation. For example, the modeler 117 may output a power cycle command to reboot a malfunctioning device. In another example, the modeler 117 may output a reset command to restore factory settings.

In yet another example, the modeler 117 may output a diagnostic command to run a system check as shown, to initiate a communication (e.g., by a routing system 118) based upon retrieved device data. Additionally, the interfacing command may be based upon the protocol, the command, or the data format of the IoT device 150 since each IoT device 150 may operate differently based upon its configuration. That is, the modeler 117, modeling the device dataset 124, may generate responses customized to the IoT device 150. For instance, the modeler 117 may initiate communication with IoT devices 150 that follow different communication standards.

In various embodiments, applying the retrieved device dataset and a natural language input as the input to the one or more AI models may include normalizing the plurality of feature vectors to a scale. For example, the scale may be a range from 0 to 1 or standard deviation units. That is, normalizing may include the modeler 117 adjusting the data to a common scale to facilitate consistent input for the AI models. In various implementations, applying the retrieved device dataset and a natural language input as the input to the one or more AI models may include the modeler 117 processing the normalized plurality of feature vectors using the one or more AI models to generate an output including one or more interfacing commands for initiating communications with the IoT device based upon at least one of the protocol, the command, or the data format of the IoT device. That is, generating interfacing commands (e.g., executing a power cycle, activating a sensor, or resetting a device) may include the modeler 117 identifying the appropriate command to manage the operations of the IoT device 150.

In certain embodiments, the AI model may be a neural network, decision tree, support vector machine, or any other analytical model. For instance, the AI model may be a generative AI model capable of analyzing historical data to predict future device requirements. For example, processing the retrieved device dataset and the natural language input may include the modeler 117 adjusting device parameters in real-time to improve performance.

In some implementations, applying the retrieved device dataset and a natural language input as the input to the one or more AI models may include the modeler 117 processing the normalized plurality of feature vectors using the one or more AI models to generate an output including (i) a natural language response regarding a status or configuration of the IoT device, and/or (ii) one or more executable commands for controlling the IoT device based upon at least one of the protocol, the command, or the data format of the IoT device. That is, natural language responses (e.g., “The device is operating at 85% efficiency,” “The water heater is currently set to 120 degrees”) regarding a status or configuration of the IoT device may include the modeler 117 querying the relevant device dataset for the most up-to-date information.

Additionally, generating one or more executable commands (e.g., reset, recalibrate, modify settings) may include the modeler 117 determining the appropriate control commands based upon the device's configuration. For example, processing the retrieved device dataset and a natural language input may include the modeler 117 adjusting the power consumption of the IoT device 150 or operational mode based upon recent patterns of use.

Moreover, applying the retrieved device dataset and a natural language input as the input to the one or more AI models may include generating an output of executable commands. The executable commands may be for controlling the IoT device 150 based upon at least one of the protocol, the command, or the data format of the IoT device. That is, modeler 117 may determine the optimal sequence of commands based upon the current state of the IoT device. For instance, a natural language input may state “Reduce the water heater's temperature by 10 degrees.” In this example, the outputted executable command may be a temperature adjustment command which may be based upon the protocol, the command, or the data format of the IoT device 150. Further in this example, the command may be based upon (i) a protocol such as Modbus, (ii) a command such as Set Temperature, (iii) or a data format such as JSON. As shown, the modeler 117 may interpret the input of the user and translate it into a specific device action.

Applying the retrieved device dataset and a natural language input as input may cause the one or more AI models of the modeler 117 to generate an output regarding commands to initiate communications with the IoT device. The commands may be based upon at least one of the protocol, the command, or the data format of the IoT device. For instance, the output may correspond to a “restart” command for a security camera. In another example, the output may correspond to an “adjust sensitivity” command for a motion sensor. That is, the output may include instructions to control the behavior of the IoT device 150. For example, the update may be related to device settings, operational parameters, communication protocols, or any other configurable attribute of the IoT device 150.

As discussed herein, the modeler 117 may utilize machine learning, generative artificial intelligence, or other advanced computing techniques. In certain embodiments, generative artificial intelligence (GenAI or GAI) models (also referred to as generative machine learning (ML) models) and/or other AI/ML models discussed herein may be implemented via and/or coupled to the modeler 117. That is, the modeler 117 may be configured to implement machine learning, facilitating the learning and adapting of the modeling system 110 operations without being explicitly programmed. Machine learning and artificial intelligence may be implemented using a variety of methods and algorithms. In one exemplary embodiment, a machine learning module or circuit within modeler 117 may be configured to implement these ML methods and algorithms to continuously improve device control strategies based upon real-time data.

In various embodiments, the GenAI or GAI models may be transformer-based models, LLM-based models, recurrent neural networks (RNNs), or any suitable AI/ML models. For instance, the GenAI model may be a transformer-based model that uses self-attention mechanisms to analyze sequential data. The transformer-based model may include multiple layers of attention heads and feed-forward networks. In another instance, the GenAI model may be an LLM-based model that uses large-scale datasets to extract insights and generate device control outputs. Generally, the GenAI models may process the device datasets by analyzing historical performance, extracting operational trends, and generating outputs based upon learned patterns unique to a particular IoT device 150 or group of IoT devices 150.

In various implementations, an AI model may be trained by the modeler 117 by using historical IoT device data (e.g., stored in model dataset 122) to learn patterns and make predictions. That is, training may include feeding the model datasets of device communications to train the AI model to recognize specific protocols and command structures. For example, a GenAI model may be trained by using labeled data of device statuses, error logs, and event histories. In this example, after training, the GenAI model may be implemented by the modeler 117 to generate outputs regarding optimal device operation and maintenance. The GenAI model may be used by the modeler 117 to adjust device configurations based upon learned operational behaviors.

In some embodiments, the modeler 117 may access and utilize multiple types of databases during both training and implementation phases to correlate and generate data pairs for analysis. For example, during training, the modeler 117 may aggregate data from different sources, such as direct device communications from the IoT device 150 and operational data or other related data from a third-party database, to cross-correlate these data points. In this example, the AI models may be trained to identify patterns and correlations between device errors and operational states, which may then be applied during implementation. During implementation, the modeler 117 may dynamically process and correlate incoming data (e.g., device datasets and natural language inputs) on the fly, using similar data sources to update device configurations and adjust operational parameters in real time based upon the available information (e.g., firmware from the IoT device 150, software updates, event logs, and/or user inputs).

In some embodiments, the GenAI model may be a supervised learning model trained on labeled device data. The AI models may include at least one large language model (LLM). The LLM may include at least one of (i) a supervised learning model trained on labeled IoT device data or (ii) an unsupervised learning model trained on unlabeled IoT device data. That is, the supervised learning model may be trained by the modeler 117 using datasets where outcomes are known and used to guide learning. For instance, protocol data, command data, or data format data labeled as operational or error states may be used to train the model to identify device configurations or operations. In some implementations, the GenAI model may be an unsupervised learning model trained on unlabeled protocol data, command data, or data format data of the device datasets 124. That is, the unsupervised learning model may be trained by the modeler 117 using data without predefined categories to identify hidden patterns. For instance, analyzing protocol data, command data, or data format data without labels to identify anomalies or irregularities. Once trained, the GenAI model may be implemented by the modeler 117 to generate predictions regarding device operations or parameters, status changes, or control recommendations.

In various implementations, the modeler 117 may facilitate reinforcement learning of the one or more models (e.g., AI model, GenAI model, etc.). Reinforcement learning may include updating the GenAI model based upon receiving feedback on the output and the at least one action from a reward signal generated from device performance improvements or user feedback. In some embodiments, the feedback may be of the output and the at least one determined action. The reward signal may be a quantitative measure of the performance of the model. For instance, the reward signal may be based upon the accuracy of a response of the IoT device 150 to control commands, operational efficiency, or user satisfaction with the natural language response.

For example, feedback on the output may be received from a user computing system 140. In this example, a user of the user computing system 140 may interact with the modeler 117 implementing a GenAI model (e.g., via a voice-activated assistant or touchscreen) by providing feedback on the outputs of the model. The feedback may be received by the modeler 117 to update the model based upon user ratings or corrections of the generated outputs of the modeler 117. The modeler 117 may use the feedback (e.g., command failure, inaccurate status report, misinterpreted input) to perform reinforcement learning on a model by refining its decision-making process. For instance, if the user corrects the response, the modeler 117 may train the model to adjust its natural language interpretation or command generation accordingly.

In some implementations, the routing system 118 may be configured to initiate a communication with the IoT device 150 using the one or more interfacing commands to obtain a status or configuration of the IoT device 150. That is, interfacing commands may be any device-specific commands, such as, but not limited to, status requests, configuration updates, diagnostics, data retrieval, command execution, and/or operational control. The interfacing commands may be used by the routing system 118 to communicate with the IoT device 150 to obtain real-time (or near real-time) data. For example, the routing system 118 may request operational data from a water heater or request the status of a security system. The status of the IoT device 150 may be any operational attribute, such as, but not limited to power level, network connectivity, error state, firmware version, configuration setting, and/or security status. The configuration of the IoT device 150 may be any operational setting, such as, but not limited to performance thresholds, alert sensitivity, device scheduling, operational mode, firmware update settings, and/or automation rules.

In various embodiments, the status or configuration of the IoT device may include sensor information corresponding to a sensor (e.g., sump pump sensor, water heater sensor, smoke detector, carbon monoxide detector, security camera, motion sensor, a door or window contact sensor, Ting sensor, garage door sensor, other sensor, etc.) monitoring a subsystem of the residential building (e.g., basement flood protection, water heating system, fire safety, security monitoring, etc.) and/or commercial building (e.g., manufacturing equipment, fire suppression systems, entry control, etc.).

In some implementations, the routing system 118 may be configured to configure (or update) the IoT device 150 by performing a command sequence using the one or more executable commands to update a parameter (e.g., temperature setting, sensitivity threshold, power mode) or control (e.g., start, stop, reset, recalibrate) of the IoT device 150. For example, the routing system 118 may configure a sump pump by modifying the activation threshold based upon water level readings. In this example, the natural language input may be, “Lower the sump pump activation threshold by 2 inches.” For example, the routing system 118 may configure a water heater by reducing its maximum temperature setting.

In this example, the natural language input may be, “Set the water heater to 110 degrees Fahrenheit.” That is, the one or more executable commands may include executable code that, when executed, controls, configures, or transmits feedback to the IoT device 150 or another connected device (e.g., a thermostat, security system) within the local network.

The execution of the executable code may be based upon a communication interface and a command format supported by the IoT device 150 or another connected device. That is, the routing system 118 may interact with various communication interfaces, such as a proprietary IoT protocol, to send the control signals. For instance, a communication interface may be any communication protocol, such as, but not limited to Zigbee, Wi-Fi, Bluetooth, Ethernet, MQTT, and/or any cloud-based IoT protocol.

In another instance, a command format may be any structured message format, such as, but not limited to JSON, XML, binary, text commands, and/or encrypted instructions. As shown, the executable commands may be used to facilitate real-time device control, adjustment of settings, or execution of specific operations. Additionally, the executable code may be any set of machine-level instructions, such as, but not limited to binary instructions, compiled code, script-based operations, or any executable logic by the IoT device 150.

In various embodiments, the communication operations performed by the routing system 118 may include pulling, in real-time (or near real-time), data corresponding to the status or configuration of the IoT device 150 responsive to one or more queries transmitted to the IoT device 150 according to the one or more interfacing commands. That is, pulling may include querying the device's sensors or status registers to retrieve the latest data. For instance, the routing system 118 may send a command to request the current temperature of a water heater or the status of a sump pump. Additionally, to pull from the IoT device 150, the routing system 118 may communicate with the data transmission interface of the IoT device 150 to access and extract the information for analysis and response.

In various embodiments, the communication operations performed by the routing system 118 pulling data corresponding to the status or configuration of the IoT device 150 responsive to one or more queries transmitted to the IoT device 150 according to the one or more interfacing commands. That is, pulling may include sending multiple queries to different IoT devices 150 and aggregating the responses for analysis. For instance, the routing system 118 may query multiple devices within a network of a building to check their operational status, such as security sensors or temperature monitors. Additionally, to pull from the IoT device 150, the routing system 118 may access the device's network stack or hardware interface to retrieve data directly. Responsive to pulling, the routing system 118 may store the pulled data in the database (e.g., in device dataset 124). For example, the routing system 118 may aggregate operational data from various IoT devices 150 and store it in the modeling database 120 for future queries. For instance, the routing system 118 may log real-time sensor readings from devices across the network.

In some arrangements, the modeler 117 may also be configured to provide, via the user interface (e.g., of the user computing system 140), the natural language response including the status or configuration of the IoT device 150. That is, the natural language response may be human-readable such that the user may interpret the information (e.g., “The sump pump is currently inactive, and water levels are below the threshold”). That is, providing the natural language response may be responsive to initiating the communication (e.g., with the IoT device 150) or querying a modeling database 120 including the status or configuration of the IoT device 150. In various embodiments, providing (e.g., over network 130) the natural language response may include presenting the response on an application of the user computing system 140. For instance, the modeler 117 may display the operational status of an IoT device 150, such as a water heater, through a mobile app interface. In another instance, the modeler 117 may update the interface in real-time with the latest status of the IoT device 150, such as the temperature reading from a thermostat.

In some implementations, the modeler 117 may create a profile of a space or area (e.g., a residential home, office, warehouse, industrial facility, and/or any other building or environment) within the local network including the device dataset 124 of the IoT device 150. In particular, a profile may be generated based upon the types of devices within the space, their operational history, and/or specific user settings. For instance, a profile for a residential home may include connected HVAC units, security systems, and environmental sensors, along with their operating parameters.

In various implementations, the modeler 117 may update a profile of the space or area within the local network by storing the device data or updating a status, usage, or configuration of the IoT device. That is, updating may include the modeler 117 logging changes to device configurations, such as modified automation routines or alert settings. For example, the modeler 117 may update a operational settings of the IoT device 150 after receiving new commands from the user or changes in the environment (e.g., increasing the set temperature of an air conditioner based upon external weather conditions).

In another example, the modeler 117 may adjust device behavior based upon usage patterns, such as reducing energy consumption during periods of inactivity. As shown, the profile may include detailed operational data, which may be used by the modeler 117 in future modeling to improve device performance and energy usage such that it learns from past actions and adjusts its recommendations or control strategies accordingly.

In certain embodiments, the modeling database 120 may be configured to store and organize data used in modeling by the modeling system 110. The data may include the model dataset 122 and the device dataset 124. The model dataset 122 may include training data used to develop and refine the AI models within the modeling system 110. The device dataset 124 may store information about the specific IoT devices, including their configurations, protocols, and operational history.

The data stored in these datasets may be accessed and processed by the modeling system 110 to perform modeling and generate outputs. For example, the modeling system 110 may retrieve data from the device dataset 124 to generate a response to a natural language input of a user regarding a specific IoT device. Additionally, the model dataset 122 may include training data and be updated by the modeling system 110 based upon new information from device operations, user feedback, or additional environmental inputs. In some embodiments, the user computing system 140 and/or IoT device 150 may access and provide data to the modeling database 120. For instance, IoT device data may be provided by the IoT devices 150 and/or user computing system 140 and stored in the device dataset 124 for future reference.

Referring still to FIG. 1, according to some embodiments, the modeling system 110 is configured to communicate with components of the interfacing system 100. For example, protection record information, protection product information, and/or data associated with the user computing system 140 and/or the IoT devices 150 may be communicated to the modeling system 110 (e.g., via the network 130). Information and/or data associated with the modeling database 120 may also be communicated to the modeling system 110 (e.g., via the network 130). In some implementations, the modeling system 110 is implemented using cloud computing services. In various implementations, the modeling system 110 is implemented using one or more computing devices, for instance, operating alone and/or in combination. In various embodiments, the modeling system 110 is implemented using computing architectures like multiple distributed servers, and/or similar computing devices and/or systems.

In certain embodiments, the modeling system 110 is another suitable computing system, for example, distributed across multiple systems or devices (e.g., which may be located within a single building or facility, or distributed across multiple different buildings or facilities), or within a single computer (e.g., one server, housing, etc.). All such implementations are contemplated herein. The modeling system 110 may be a virtual reality (VR) system or augmented reality (AR) system, for example, to provide digital connections between a plurality of metadata sources, where the metadata sources are integrated within the VR system or AR system. The modeling system 110 may include one or more local or remote processors, servers, transceivers, sensors, memory units, mobile devices, wearables, smartwatches, smart rings, smart contact lenses, smart glasses, augmented reality glasses, virtual reality headsets, mixed or extended reality glasses or headsets, voice bots, chatbots, and/or other electronic or electrical components, which may be in wired or wireless communication with one another.

As shown, the modeling system 110 may be configured to communicate with the user computing system 140. In various implementations, the user computing system 140 may include one or more processing circuits 142, including processor(s) 143 and memory 144. The memory 144 may have instructions stored thereon that, when executed by processor(s) 143, cause the one or more processing circuits 142 to perform the various operations described herein. The operations described herein may be implemented using software, hardware, or a combination thereof. The processor(s) 143 may include a microprocessor, ASIC, FPGA, etc., or combinations thereof. In many implementations, processor(s) 143 may be a multi-core processor or an array of processors. Memory 144 may include, but is not limited to, electronic, optical, magnetic, or any other storage devices capable of providing processor(s) with program instructions. The instructions may include code from any suitable computer programming language.

In some implementations, the user computing system 140 may be used for interacting with an interface to provide natural language outputs and receive natural language inputs regarding IoT devices 150. For instance, the user computing system 140 may provide access to a dashboard where users may input queries or commands to control or receive status updates from IoT devices 150 (e.g., “What is the temperature in the warehouse?” or “Turn off all motion sensors”). The user computing system 140 may also receive visual feedback (e.g., charts, graphs, status indicators) on the performance and status of connected devices. The user computing system 140 may perform additional functions such as storing device configurations, setting up automation sequences, and managing device alerts. In certain embodiments, the user computing system 140 may execute commands to update device configurations based upon user preferences (e.g., updating security camera sensitivity based upon input thresholds).

In certain embodiments, the user computing system 140 may be another suitable computing system, for example, distributed across multiple systems or devices (e.g., which may be located within a single building or facility, or distributed across multiple different buildings or facilities), or within a single computer (e.g., one server, housing, etc.). All such implementations are contemplated herein. The user computing system 140 may include one or more local or remote processors, servers, transceivers, sensors, memory units, mobile devices, wearables, smartwatches, smart rings, smart contact lenses, smart glasses, augmented reality glasses, virtual reality headsets, mixed or extended reality glasses or headsets, voice bots, chatbots, and/or other electronic or electrical components, which may be in wired or wireless communication with one another.

In various embodiments, the input/output device 145 may be configured to facilitate communication between the user and the system (e.g., via touch input, voice commands, or gesture recognition). For example, the input/output device 145 may be used to receive commands from the user (e.g., “Activate all security systems” or “Set temperature to 72 degrees”) and provide real-time responses to the user (e.g., “All systems activated” or “Temperature set to 72 degrees”). The input/output device 145 may include various peripherals such as keyboards, touchscreens, virtual reality headsets, augmented reality headsets, sensors, scanners, displays, and cameras. These peripherals support the interaction between the user and the IoT devices, allowing for control of connected devices. The input/output device 145 may also provide real-time feedback (e.g., showing the status of devices, sensor data, or control options).

Additionally, the modeling system 110 may be configured to communicate with the IoT devices 150. In certain embodiments, the IoT devices 150 may include one or more processing circuits 152, including processor(s) 153 and memory 154. The memory 154 may have instructions stored thereon that, when executed by processor(s) 153, cause the one or more processing circuits 152 to perform the various operations described herein. The operations described herein may be implemented using software, hardware, or a combination thereof. The processor(s) 153 may include a microprocessor, ASIC, FPGA, etc., or combinations thereof. In many implementations, processor(s) 153 may be a multi-core processor or an array of processors. Memory 154 may include, but is not limited to, electronic, optical, magnetic, or any other storage devices capable of providing processor(s) with program instructions. The instructions may include code from any suitable computer programming language.

In various implementations, the IoT devices 150 may communicate with the user computing system 140 and/or the modeling system 110 and modeling database 120. For instance, the modeling system 110 may receive transmissions from the IoT device 150 (e.g., directly through device-to-device communication protocols such as MQTT, or indirectly through a central server). For example, the transmissions may include data on device status, alerts, or sensor readings. Additionally, the IoT devices 150 may receive interfacing commands and, in response, execute the commands (e.g., adjusting sensor sensitivity, activating alarms, or resetting configuration settings). Further, the IoT devices 150 may receive command sequences of one or more executable commands for executing. That is, the IoT devices 150 may be used to perform command sequences and, in response, may send confirmation or status updates back to the modeling system 110.

In certain embodiments, the IoT device 150 may be another suitable computing system, for example, distributed across multiple systems or devices (e.g., which may be located within a single building or facility, or distributed across multiple different buildings or facilities), or within a single computer (e.g., one server, housing, etc.). All such implementations are contemplated herein. The IoT device 150 may include one or more local or remote processors, servers, transceivers, sensors, memory units, mobile devices, wearables, smartwatches, smart rings, smart contact lenses, smart glasses, augmented reality glasses, virtual reality headsets, mixed or extended reality glasses or headsets, voice bots, chatbots, and/or other electronic or electrical components, which may be in wired or wireless communication with one another.

In some implementations, the input/output device 155 may be configured to receive user inputs, display device statuses, or control IoT devices 150 through various peripherals. For example, the input/output device 155 may be used by the modeling system 110 to display real-time sensor data from IoT devices or to receive user commands for controlling those devices. The input/output device 155 may include various peripherals such as keyboards, touchscreens, virtual reality headsets, augmented reality headsets, sensors, scanners, displays, and cameras. The keyboards, touchscreens, virtual reality headsets, augmented reality headsets, sensors, displays, and cameras may also be used to facilitate device configuration, providing an interface for adjusting settings, reviewing logs, or monitoring performance in real-time.

In certain embodiments, generative artificial intelligence (AI) models (also referred to as generative machine learning (ML) models) may be utilized with the present embodiments, and the voice bots or chatbots discussed herein may be configured to utilize artificial intelligence and/or machine learning techniques. For instance, the voice or chatbot may be a ChatGPT chatbot. The voice or chatbot may employ supervised or unsupervised machine learning techniques, which may be followed by, and/or used in conjunction with, reinforced or reinforcement learning techniques. The voice or chatbot may employ the techniques utilized for ChatGPT. The voice bot, chatbot, ChatGPT-based bot, ChatGPT bot, and/or other bots may generate audible or verbal output, text or textual output, visual or graphical output, output for use with speakers and/or display screens, and/or other types of output for user and/or other computer or bot consumption.

### Exemplary Modeling System & Functionality

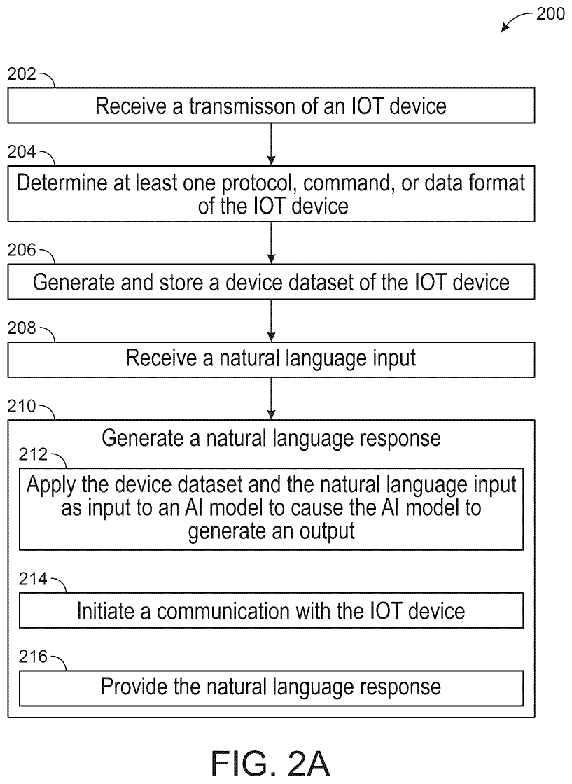

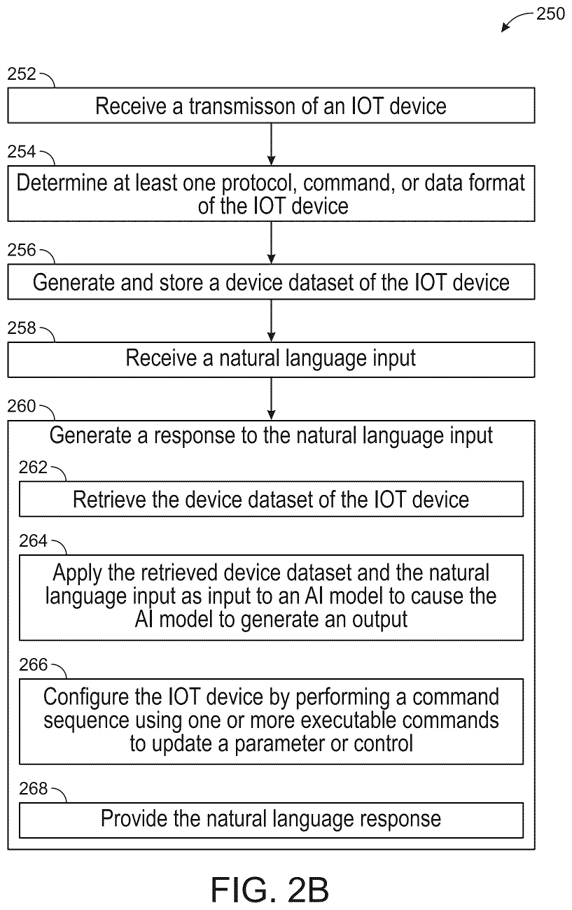

Referring now to FIG. 2A, a computer-implemented or computer-based process, shown as process 200, of interfacing with a plurality of IoT devices is shown, according to some embodiments. That is, process 200 may include interfacing with a plurality of Internet of Things (IoT) devices within a local network of a residential building using one or more artificial intelligence (AI) models. Computer-implemented process 200 may be implemented by any and/or all the components of the interfacing system 100 of FIG. 1 (e.g., the modeling system 110, etc.). It should be appreciated that any and/or all the process 200 may be implemented by other systems, devices, and/or components (e.g., components of the interfacing system 100, the modeling system 110, etc.). Further, it should be appreciated that, in various embodiments, process 200 may be implemented using additional, different, and/or fewer operations, actions, and/or functionality.

The computer-implemented method 200 may be implemented via one or more local or remote processors, servers, transceivers, sensors, memory units, mobile devices, wearables, smart watches, smart rings, smart contact lenses, smart glasses, augmented reality glasses, virtual reality headsets, mixed or extended reality glasses or headsets, voice bots or chatbots, ChatGPT bots, InstructGPT bots, Codex bots, Google Bard bots, and/or other electronic or electrical components, which may be in wired or wireless communication with one another.

Computer-implemented process 200 may include receiving at least one transmission of an IoT device of a plurality of IoT devices connected within the local network (block 202), according to some embodiments. In certain embodiments, receiving the transmissions may include the processing circuits monitoring the communication flow between the IoT device and the network router. That is, the processing circuits may intercept the data packets before they reach the routing device, enabling real-time analysis of the data. For example, the processing circuits may be configured to capture the transmission of a sensor signal (e.g., from a sump pump or water heater) before it is received by the router. In some embodiments, receiving may include monitoring a communication channel between the routing device and the IoT device and identifying the at least one data transmission from the communication channel prior to receival by the routing device.

Computer-implemented process 200 may include determining, using the at least one transmission, at least one of a protocol, a command, or a data format of the IoT device (block 204), according to some embodiments. Determining may include the processing circuits analyzing the packet structure to extract the protocol information. For example, the determining may be performed by identifying the specific protocol header used by the IoT device, such as TCP, UDP, or MQTT. In various embodiments, the processing circuits may analyze the communication header for embedded command structures. For instance, the processing circuits may extract a command to adjust a device setting (e.g., HVAC temperature or sump pump activation threshold). In another example, the processing circuits may decode the data format to interpret sensor values, such as temperature, humidity, or device status. In some embodiments, the processing circuits may determine at least one of the protocol, the command, or the data format of the IoT device based at least on (i) a network packet structure, (ii) at least one communication header, or (iii) payload data of the at least one data transmission.

Computer-implemented process 200 may include generating and storing a device dataset including at least one of the protocol, the command, or the data format of the IoT device (block 206), according to some embodiments. Generating may include the processing circuits constructing a dataset that maps specific device commands to their corresponding protocols and data formats. For instance, the determining may be performed by logging unique command transmitted by the IoT device. Storing may include the processing circuits maintaining the dataset in a memory location accessible for future retrieval and reference. For example, the storing may be performed in a distributed database shared across the local network.

In certain embodiments, the processing circuits may analyze the stored data to generate insights regarding device performance or user preferences. For example, the dataset may be used to streamline the generation of control commands in response to user inputs. For instance, the processing circuits may identify patterns in device usage based upon the collected transmission data. In various embodiments, the device dataset may be structured into a knowledge graph or vector space model compatible with performing RAG (e.g., by the AI model). For example, the RAG may include a ranking function for prioritizing retrieved device dataset from the device dataset based upon a relevance score between the retrieved device dataset and the received natural language input.

Computer-implemented process 200 may include receiving, via a user interface, a natural language input corresponding to the IoT device (block 208), according to some embodiments. Receiving may include the processing circuits interpreting the natural language input of a user via a voice command or typed text in an application. For example, the receiving may be performed by a mobile app connected to the smart home system of the user, allowing them to inquire about the status of their IoT devices. In some embodiments, the processing circuits may route the natural language input to the AI model for further processing and analysis. For example, the processing circuits may convert the natural language input into a structured query format that may be used to retrieve relevant data from the device dataset. In another instance, the processing circuits may interact with external APIs to fetch additional data needed to process the request of the user.

Computer-implemented process 200 may include generating a natural language response to the natural language input using retrieval-augmented generation (RAG) (block 210), according to some embodiments. Generally, generating may include the processing circuits retrieving the relevant data from the device dataset and applying it to the AI model to generate the appropriate response. For example, the generating may be performed by combining the retrieved device data (e.g., sensor readings, operational states) with predefined response templates to generate an output. In some embodiments, the processing circuits may update the response based upon the interaction history of the user or device configuration. For example, the processing circuits may adjust the response based upon user preferences. In another instance, the processing circuits may incorporate real-time device data into the response for immediate updates. In some embodiments, the one or more AI models may include a large language model (LLM). For example, the LLM may include at least one of (i) a supervised learning model trained on labeled IoT device data or (ii) an unsupervised learning model trained on unlabeled IoT device data. In some arrangements, generating the natural language response to the natural language input using retrieval-augmented generation (RAG) may include retrieving the device dataset of the IoT device.

At block 210, the generating may include applying the device dataset and the natural language input as input to the one or more AI models to cause the one or more AI models to generate an output including one or more interfacing commands for initiating communications with the IoT device based upon at least one of the protocol, the command, or the data format of the IoT device (block 212). Applying may include the processing circuits mapping the natural language input to the appropriate device commands and protocol structures. For example, the applying may be performed by translating the request of the user (e.g., “Turn off the water heater”) into a device-specific control command. In various arrangements, the processing circuits may adjust the interfacing commands based upon the current status of the IoT device or environmental conditions. For instance, the processing circuits may modify a heating schedule based upon real-time temperature data.

At block 210, the generating may include initiating a communication with the IoT device using the one or more interfacing commands to obtain a status or configuration of the IoT device (block 214). Initiating may include the processing circuits sending the interfacing command to the IoT device through the established communication channel. For example, the initiating may be performed by transmitting a request to the HVAC system to report its current operating state. In various arrangements, the processing circuits may configure the communication protocol based upon the capabilities of the IoT device. For example, the processing circuits may initiate a direct query to the device using MQTT, or a query using HTTP-based APIs. In another example, the processing circuits may initiate communication using a secure encrypted channel to prevent unauthorized access to the IoT devices.

In some implementations, the status or configuration of the IoT device may include sensor information corresponding to a sensor monitoring a subsystem of the residential building. That is, the status may include real-time readings such as temperature, humidity, or motion detection within the monitored space. Additionally, the natural language input may include a request to obtain the sensor information or control the sensor. In various arrangements, the sensor monitoring the subsystem may include at least one of a sump pump sensor, a water heater sensor, a HVAC sensor, a smoke detector, a carbon monoxide detector, a security camera, an attic humidity sensor, a garage door position sensor, a motion sensor, a Ting sensor, a door bell sensor, a door or window contact sensor, or other sensor or electronic device.

In various embodiments, initiating a communication may include pulling, in real-time, data corresponding to the status or configuration of the IoT device responsive to one or more queries transmitted to the IoT device according to the one or more interfacing commands. For example, the communication may be performed in real-time or near real-time. In some embodiments, initiating a communication may include pulling data corresponding to the status or configuration of the IoT device responsive to one or more queries transmitted to the IoT device according to the one or more interfacing commands. Additionally, the processing circuits may store the pulled data in the database. For example, the communication may be performed periodically.

At block 210, the generating may include providing, via the user interface, the natural language response including the status or configuration of the IoT device (block 216). Providing may include the processing circuits transmitting the response to the device of the user (e.g., a smartphone or tablet) for display. For example, the providing may be performed by sending the natural language response (e.g., “The water heater is currently set to 120 degrees”) to the mobile app of the user in real time.

In various arrangements, the processing circuits may format the response based upon the device type or the preferences of the user. For example, the processing circuits may provide a more detailed response for various queries involving multiple IoT devices. In another example, the processing circuits may provide a visual representation of the data, such as a chart showing the historical temperature readings of a water heater. In some implementations, providing the natural language response is responsive to initiating the communication or querying a database including the status or configuration of the IoT device.

In various embodiments, the processing circuits may create a profile of a space or area within the local network including the device dataset of the IoT device. For example, the home or building may be associated with a digital profile having one or more spaces or areas. In some implementations, the processing circuits may update the profile of the space or area within the local network by storing the device data or updating the status, a usage, or the configuration of the IoT device.

Referring now to FIG. 2B, a computer-implemented or computer-based process, shown as process 250, of interfacing with a plurality of IoT devices is shown, according to some embodiments. That is, process 250 may include interfacing with a plurality of Internet of Things (IoT) devices within a local network using one or more artificial intelligence (AI) models. Computer-implemented process 250 may be implemented by any and/or all the components of the interfacing system 100 of FIG. 1 (e.g., the modeling system 110, etc.). It should be appreciated that any and/or all the process 250 may be implemented by other systems, devices, and/or components (e.g., components of the interfacing system 100, the modeling system 110, etc.). Further, it should be appreciated that, in various embodiments, process 250 may be implemented using additional, different, and/or fewer operations, actions, and/or functionality.

The computer-implemented method 250 may be implemented via one or more local or remote processors, servers, transceivers, sensors, memory units, mobile devices, wearables, smart watches, smart rings, smart contact lenses, smart glasses, augmented reality glasses, virtual reality headsets, mixed or extended reality glasses or headsets, voice bots or chatbots, ChatGPT bots, InstructGPT bots, Codex bots, Google Bard bots, and/or other electronic or electrical components, which may be in wired or wireless communication with one another.

Computer-implemented process 250 may include receiving at least one data transmission of an IoT device of a plurality of IoT devices connected within the local network (block 252). Computer-implemented process 250 may include determining, using the received at least one data transmission, at least one of a protocol, a command, or a data format of the IoT device (block 254), according to some implementations. Computer-implemented process 250 may include generating and storing a device dataset including at least one of the protocol, the command, or the data format of the IoT device (block 256), according to some arrangements. Computer-implemented process 250 may include receiving, via a user interface, a natural language input corresponding to controlling or configuring the IoT device (block 258), according to various implementations. Computer-implemented process 250 may include generating a response to the natural language input using retrieval-augmented generation (RAG) (block 260), according to various arrangements.

At block 260, the generating may include retrieving the device dataset of the IoT device (block 262). At block 260, the generating may include applying the retrieved device dataset and the natural language input as input to the one or more AI models to cause the one or more AI models to generate an output including (i) a natural language response regarding a status or configuration of the IoT device and (ii) one or more executable commands for controlling the IoT device based upon at least one of the protocol, the command, or the data format of the IoT device (block 264).

At block 260, the generating may include configuring the IoT device by performing a command sequence using the one or more executable commands to update a parameter or control of the IoT device (block 266). Also at block 260, the generating may include providing, via the user interface, the natural language response including the status or configuration of the IoT device responsive to the configuring (block 268). In some implementations, the one or more executable commands may include executable code that, when executed, controls, configures, or transmits feedback to the IoT device or another connected device within the local network based upon a communication interface and a command format supported by the IoT device or the another connected device.

### Exemplary Computing System

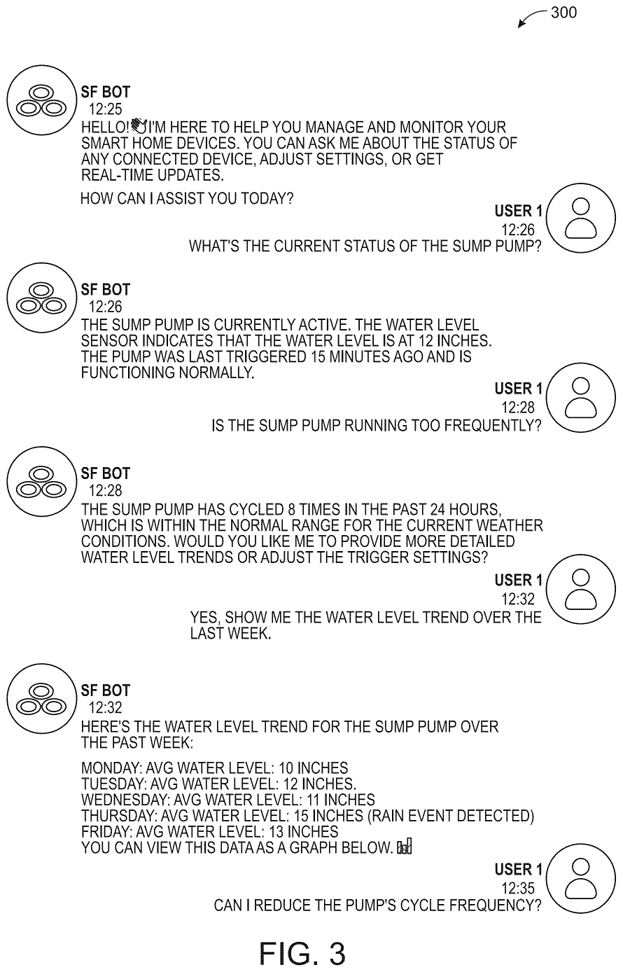

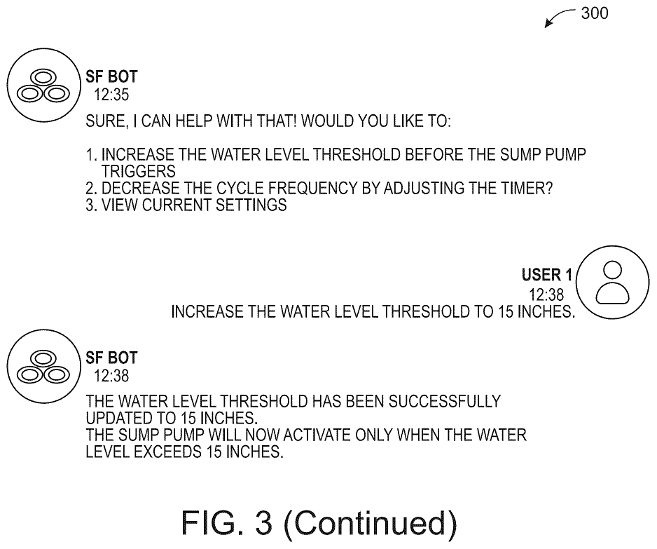

Referring now to FIG. 3, an example sequence 300 of non-limiting interactions between a user and the modeling system 110 is shown. In some implementations, the user may provide natural language inputs to the modeling system 110 via an interface to retrieve real-time status information and control various IoT devices. The modeling system 110, in response to one or more inputs, may generate corresponding outputs by interfacing with a plurality of IoT devices within a network. For example, the user may query the current status of a sump pump in their residential house, and the modeling system 110 may respond with relevant device data, such as operational status, water level, and last activation time. In this example, the user may provide additional inputs to adjust the operational parameters of the sump pump. That is, the modeling system 110 may process the natural language input and generates control commands to adjust, for example, the water level threshold. In some embodiments, the modeling system 110 may confirm that the adjustment (or update) has been successfully applied, updating the sump pump configuration accordingly.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied, or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor and may be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

In various implementations, a computer program is provided, and the program is embodied on a computer readable medium. In various embodiments, the system is executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality.

In various implementations, the system includes multiple components distributed among a plurality of computing devices. One or more components may be in the form of computer-executable instructions embodied in a computer-readable medium. The systems and processes are not limited to the specific embodiments described herein. In addition, components of each system and each process may be practiced independent and separate from other components and processes described herein. Each component and process may also be used in combination with other assembly packages and processes.

The construction and arrangement of the systems and methods as shown in the various example embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For instance, the position of elements may be reversed or otherwise varied, and the nature or number of discrete elements or positions may be altered or varied. Accordingly, all such modifications are intended to be included within the scope of the present disclosure. The order or sequence of any process or method operations, actions, or functionality may be varied or re-sequenced according to alternative embodiments. Other substitutions, modifications, changes, and omissions may be made in the design, operating conditions, and arrangement of the example embodiments without departing from the scope of the present disclosure.

As used herein, an element or operation recited in the singular and proceeded with the word “a” or “an” should be understood as not excluding plural elements or operations, unless such exclusion is explicitly recited. Furthermore, references to “exemplary embodiment,” “one embodiment,” or “some embodiment” of the present disclosure are not intended to be interpreted as excluding the existence of additional embodiments that also incorporate the recited features.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The patent claims at the end of this document are not intended to be construed under 35 U.S.C. § 112(f) unless traditional means-plus-function language is expressly recited, such as “means for” or “step for” language being expressly recited in the claim(s).

Although the Figures show a specific order of method operations, actions, or functionality, the order of such may differ from what is depicted. Also, two or more operations, actions, or functionalities may be performed concurrently or with partial concurrence. Such variation will depend on the software and hardware systems chosen and on designer choice. All such variations are within the scope of the disclosure. Likewise, software implementations may be accomplished with standard programming techniques with rule-based logic and other logic to accomplish the various connection operations or actions, processing operations or actions, comparison operations or actions, and decision operations or actions.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The term “coupled” and variations thereof, as used herein, means the joining of two members directly or indirectly to one another. Such joining may be stationary (e.g., permanent, or fixed) or moveable (e.g., removable, or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

In various implementations, the functionality and operations described herein may be performed on one processor or in a combination of two or more processors. For example, in some implementations, the various operations may be performed in a central server or set of central servers configured to receive data from one or more devices (e.g., edge computing devices/controllers) and perform the operations. In some implementations, the operations may be performed by one or more local controllers or computing devices (e.g., edge devices), such as controllers dedicated to and/or located within a particular industrial environment or portion of an industrial environment. Additionally or alternatively, the operations may be performed by a combination of one or more central or offsite computing devices/servers and one or more local controllers/computing devices. All such implementations are contemplated within the scope of the present disclosure.

Further, unless otherwise indicated, when the present disclosure refers to one or more computer-readable storage media and/or one or more controllers, such computer-readable storage media and/or one or more controllers may be implemented as one or more central servers, one or more local controllers or computing devices (e.g., edge devices), any combination thereof, or any other combination of storage media and/or controllers regardless of the location of such devices.

What is claimed is:

1. A system for interfacing with a plurality of Internet of Things (IoT) devices within a local network of a residential building using one or more artificial intelligence (AI) models, comprising:
one or more memory devices having instructions stored thereon that, when executed by one or more processors, cause the one or more processors to perform operations comprising:
receiving at least one transmission of an IoT device of a plurality of IoT devices connected within the local network;
determining, using the at least one transmission, at least one of a protocol, a command, or a data format of the IoT device;
generating and storing a device dataset comprising the at least one of the protocol, the command, or the data format of the IoT device;
receiving, via a user interface, a natural language input corresponding to the IoT device; and
generating a natural language response to the natural language input using retrieval-augmented generation (RAG) by:
applying the device dataset and the natural language input as input to the one or more AI models to cause the one or more AI models to generate an output comprising one or more interfacing commands for initiating communications with the IoT device based upon at least one of the protocol, the command, or the data format of the IoT device;
initiating a communication with the IoT device using the one or more interfacing commands to obtain a status or configuration of the IoT device; and
generating the natural language response using the status or configuration of the IoT device.

2. The system of claim 1, wherein the status or configuration of the IoT device comprises sensor information corresponding to a sensor monitoring a subsystem of the residential building, and wherein the natural language input comprises a request to obtain the sensor information or control the sensor.

3. The system of claim 2, wherein the sensor monitoring the subsystem comprises at least one of a sump pump sensor, a water heater sensor, a HVAC sensor, a smoke detector, a carbon monoxide detector, a security camera, an attic humidity sensor, a garage door position sensor, a motion sensor, or a door or window contact sensor.

4. The system of claim 1, wherein the operations further comprise:
forwarding the at least one transmission to a routing device, the routing device communicably coupled to the IoT device, and wherein receiving comprises monitoring a communication channel between the routing device and the IoT device and identifying the at least one transmission from the communication channel prior to receival by the routing device.

5. The system of claim 1, wherein determining at least one of the protocol, the command, or the data format of the IoT device is based at least on (i) a network packet structure, (ii) at least one communication header, or (iii) payload data of the at least one transmission, and wherein providing the natural language response is responsive to initiating the communication or querying a database comprising the status or configuration of the IoT device.

6. The system of claim 1, wherein the one or more AI models comprise a large language model (LLM), and wherein the LLM comprise at least one of (i) a supervised learning model trained on labeled IoT device data or (ii) an unsupervised learning model trained on unlabeled IoT device data, and wherein generating the natural language response to the natural language input using retrieval-augmented generation (RAG) comprises retrieving the device dataset of the IoT device.

7. The system of claim 1, wherein the device dataset is structured into a knowledge graph or vector space model compatible with performing RAG, and wherein the RAG comprises a ranking function for prioritizing retrieved device dataset from the device dataset based upon a relevance score between the retrieved device dataset and the received natural language input.

8. The system of claim 1, wherein the operations further comprise:
creating a profile of a space or area within the local network comprising the device dataset of the IoT device; or
updating the profile of the space or area within the local network by storing the device dataset or updating the status, a usage, or the configuration of the IoT device.

9. The system of claim 1, wherein initiating the communication comprises:
pulling, in real-time, data corresponding to the status or configuration of the IoT device responsive to one or more queries transmitted to the IoT device according to the one or more interfacing commands.

10. The system of claim 1, wherein initiating the communication comprises:
pulling data corresponding to the status or configuration of the IoT device responsive to one or more queries transmitted to the IoT device according to the one or more interfacing commands; and
storing the pulled data in a database.

11. A system for interfacing with a plurality of Internet of Things (IoT) devices within a local network using one or more artificial intelligence (AI) models, comprising:
one or more memory devices having instructions stored thereon that, when executed by one or more processors, cause the one or more processors to perform operations comprising:
determining at least one of a protocol, a command, or a data format of an IoT device;
generating and storing a device dataset comprising at least one of the protocol, the command, or the data format of the IoT device;
receiving, via a user interface, a natural language input corresponding to the IoT device; and
generating a response to the natural language input using retrieval-augmented generation (RAG) by:
retrieving the device dataset of the IoT device;
applying the retrieved device dataset and the natural language input as input to the one or more AI models to cause the one or more AI models to generate an output comprising one or more interfacing commands for initiating communications with the IoT device based upon at least one of the protocol, the command, or the data format of the IoT device;
initiating a communication with the IoT device using the one or more interfacing commands; and
providing, via the user interface, the response responsive to initiating the communication.

12. The system of claim 11, wherein the operations further comprise:
forwarding at least one transmission to a routing device, the routing device communicably coupled to the IoT device, and wherein receiving comprises monitoring a communication channel between the routing device and the IoT device and identifying the at least one transmission from the communication channel prior to receival by the routing device.

13. The system of claim 12, wherein determining at least one of the protocol, the command, or the data format of the IoT device is based at least on (i) a network packet structure, (ii) at least one communication header, or (iii) payload data of the at least one transmission.

14. The system of claim 11, wherein the one or more AI models comprise a large language model (LLM), and wherein the LLM comprise at least one of (i) a supervised learning model trained on labeled IoT device data or (ii) an unsupervised learning model trained on unlabeled IoT device data.

15. The system of claim 11, wherein the device dataset is structured into a knowledge graph or vector space model compatible with performing RAG, and wherein the RAG comprises a ranking function for prioritizing retrieved device dataset from the device dataset based upon a relevance score between the retrieved device dataset and the received natural language input.

16. The system of claim 11, wherein the operations further comprise:
creating a profile of a space or area within the local network comprising the device dataset of the IoT device; or
updating the profile of the space or area within the local network by storing the device dataset or updating a status, a usage, or a configuration of the IoT device.

17. The system of claim 11, wherein initiating the communication comprises:
pulling, in real-time, data corresponding to a status or configuration of the IoT device responsive to one or more queries transmitted to the IoT device according to the one or more interfacing commands.

18. The system of claim 11, wherein initiating the communication comprises:
pulling data corresponding to a status or configuration of the IoT device responsive to one or more queries transmitted to the IoT device according to the one or more interfacing commands; and
storing the pulled data into a database.

19. A system for controlling a plurality of Internet of Things (IoT) devices within a local network using one or more artificial intelligence (AI) models, comprising:
one or more memory devices having instructions stored thereon that, when executed by one or more processors, cause the one or more processors to perform operations comprising:
receiving at least one data transmission of an IoT device of a plurality of IoT devices connected within the local network;
determining, using the received at least one data transmission, at least one of a protocol, a command, or a data format of the IoT device;
generating and storing a device dataset comprising at least one of the protocol, the command, or the data format of the IoT device;
receiving, via a user interface, a natural language input corresponding to controlling or configuring the IoT device; and
generating a response to the natural language input using retrieval-augmented generation (RAG) by:
retrieving the device dataset of the IoT device;
applying the retrieved device dataset and the natural language input as input to the one or more AI models to cause the one or more AI models to generate an output comprising (i) a natural language response regarding a status or configuration of the IoT device and (ii) one or more executable commands for controlling the IoT device based upon at least one of the protocol, the command, or the data format of the IoT device;
configuring the IoT device by performing a command sequence using the one or more executable commands to update a parameter or control of the IoT device; and
providing, via the user interface, the natural language response comprising the status or configuration of the IoT device responsive to the configuring.

20. The system of claim 19, wherein the one or more executable commands comprise executable code that, when executed, controls, configures, or transmits feedback to the IoT device or another connected device within the local network based upon a communication interface and a command format supported by the IoT device or the another connected device.
